(19) United States
(12) Patent Application Publication
(10) Pub. No.: US 2006/0003899 A1
(43) Pub. Date: Jan. 5, 2006

(54) Drilling fluid and methods of use thereof

(76) Inventors: Simon J.M. Levey, Calgary (CA); John Ewanek, Calgary (CA)

Correspondence Address: Blake, Cassels & Graydon LLP, Box 25, Commerce Court West, 199 Bay Street, Toronto, ON, M5L 1A9, CA

(21) Appl. No.: 11/142,352

(22) Filed: Jun. 2, 2005

Related U.S. Application Data
(63) Continuation of application No. PCT/CA03/01873, filed on Dec. 2, 2003.
(60) Provisional application No. 60/441,162, filed on Jan. 21, 2003.
(60) Provisional application No. 60/430,045, filed on Dec. 2, 2002.

(51) Int. Cl. C09K 8/03; C09K 8/04

(52) U.S. Cl. 507/120

(57) ABSTRACT

The present invention relates to an aqueous drilling fluid used for drilling bitumen or heavy oil rich formations. The aqueous drilling fluid comprising; a water soluble cationic polymer capable of encapsulating the bitumen or heavy oil. The encapsulation of bitumen prevents the accretion of bitumen to drill components.

### CROSS REFERENCE TO RELATED APPLICATIONS

This application is a continuation of international application number PCT/CA2003/01873, filed Dec. 2, 2003, the content of which is incorporated herein by reference, and claims the benefit of U.S. Provisional Application No. 60/430,045, filed Dec. 2, 2002, and U.S. Provisional Application No. 60/441,162, filed Jan. 21, 2003, the contents of which are incorporated herein by reference.

### BACKGROUND OF THE INVENTION

1. Field of the Invention

The present invention relates to water based drilling fluids used for drilling subterranean formations containing heavy crude oil and tar sand oil, including bitumen.

2. Description of the Prior Art

In drilling subterranean wells, drilling fluids are expected to perform a number of functions and have certain characteristics depending on the formation that is being drilled. The drilling fluid must be able to efficiently remove freshly drilled cuttings from the drill bit and transport them up the annular space between the well-bore and the drill-pipe where they can be removed at the surface by mechanical or physical means. The chemistry and composition of the drilling fluid must also provide borehole stability in uncased sections, cool and lubricate the bit, reduce friction, and also provide a low permeable thin filter cake to reduce fluid influx into the formation.

There are three main classes of drilling fluids: 1) water based drilling fluids, where the continuous phase is water; 2) oil based drilling fluids, where the continuous phase is oil, wherein water or brine may be emulsified using calcium soaps or other emulsifiers; and 3) gaseous or compressible fluids, where air or gas is injected into the drilling fluid.

A drilling fluid will typically contain three types of solids: 1) organic polymers and clays, which give the fluid viscosity and aid in fluid loss control; 2) weighting materials, which are heavy inert minerals used to increase the density of drilling fluid or act as bridging solids; and 3) formation solids, which are dispersed in the fluid while the formation is being drilled. The latter is commonly referred to as “cuttings” or “drill cuttings”.

In the majority of cases the formation solids or cuttings that are generated while drilling will contain various clays, shale and sand depending on the nature of the formation that is being drilled. In some regions of the world, the minerals obtained from formations are covered in bitumen or heavy oil.

Oil sand deposits represent a vast source of relatively untapped bitumen reserves. For example, in regions of North America, and more specifically Northern Alberta, Canada, oil sand deposits have been estimated to contain over 300 billion barrels of oil. These natural bitumen deposits are estimated to cover an area of at least 45,000 km². Mining of bitumen deposits is accomplished through both conventional surface methods and more cost effective technologies such as Steam Assisted Gravity Drainage (SAGD). The latter method involves drilling a number of horizontal wells in bitumen rich formations, one on top of another. Bitumen is a substance characterized by its high viscosity and density, and as a result it will not flow under normal conditions. For this reason, steam or heated gas is often pumped underground, into the formation, in order to heat the bitumen and increase its flowability. The heated bitumen can then be recovered and processed.

A major problem encountered during drilling of bitumen rich deposits is that bituminous material, due to its high viscosity, accretes (or sticks) to drill components. As a result, time is wasted in keeping elements of the drilling operation clean from bitumen accumulations. For example, when drilling bitumen rich formations, bituminous material often accretes (or sticks) to the drill-string, Bottom Hole Assembly (BHA) or surface handling and solids control equipment. This forces operators to remove the accumulated bitumen, which results in the halting of drilling operations and a decrease in productivity.

Conventional drilling fluids by themselves are unable to prevent the accretion of bitumen to drill components. In an attempt to overcome the problem of bitumen accretion (sticking), drilling fluids are often provided with additives that are used to counteract the accumulation of bitumen on drill components. Solvents are an example of a commonly used additive for the prevention of bitumen accretion. Solvents are used as thinners to dissolve the bitumen and decrease its viscosity, thereby facilitating the removal of bitumen from the surface of drill components. However, solvent containing drilling fluids are characterized by specific deficiencies. The major problem with the use of solvent additives is that they make it very difficult to separate the bitumen/solvent from the water continuous phase using existing solids control methods. Bitumen is characterized by a wide range of chemical properties, including both hydrophobicity and hydrophilicity, and as a result not all of the bitumen can be dissolved by an individual solvent. In addition, bitumen contains a number of natural surfactants that are water soluble, and the presence of these surfactants can lead to foaming. As solvents dissolve the bitumen, surfactants are released into the water phase resulting in increased foaming. In the result, further processes and costs are needed to deal with this foaming issue.

It is an object of the present invention to provide a drilling fluid which overcomes at least some of the deficiencies in the prior art.

### SUMMARY OF THE INVENTION

In one embodiment the invention provides an aqueous drilling fluid for drilling wells through a formation containing bitumen and/or heavy oil sands, the drilling fluid comprising:
a water soluble cationic polymer, wherein said cationic polymer is a copolymer comprising acrylamide or substituted acrylamide, and cationic monomers.

In another embodiment, the drilling fluid of the present invention comprises a cationic polymer wherein the cationic polymer is a copolymer comprising acrylamide or substituted acrylamide, and a cationic monomers that is an acrylate or, quaternary or acid salt of an acrylate.

In another embodiment, the drilling fluid of the present invention comprises a cationic polymer wherein the cationic polymer is a copolymer comprising acrylamide or substituted acrylamide, and a cationic monomer selected from the group consisting of dimethylaminoethyl acrylate methyl chloride quaternary salt; dimethylaminoethyl acrylate methyl sulfate quaternary salt; dimethyaminoethyl acrylate benzyl chloride quaternary salt; dimethylaminoethyl acrylate sulfuric acid salt; dimethylaminoethyl acrylate hydrochloric acid salt; dimethylaminoethyl methacrylate methyl chloride quaternary salt; dimethylaminoethyl methacrylate methyl sulfate quaternary salt; dimethylaminoethyl methacrylate benzyl chloride quaternary salt; dimethylaminoethyl methacrylate sulfuric acid salt; dimethylaminoethyl methacrylate hydrochloric acid salt; dialkylaminoalkylacrylamides or methacrylamides and their quaternary or acid salts such as acrylamidopropyltrimethylammonium chloride; dimethylaminopropyl acrylamide methyl sulfate quaternary salt; dimethylaminopropyl acrylamide sulfuric acid salt; dimethylaminopropyl acrylamide hydrochloric acid salt; methacrylamidopropyltrimethylammonium chloride; dimethylaminopropyl methacrylamide methyl sulfate quaternary salt; dimethylaminopropyl methacrylamide sulfuric acid salt; dimethylaminopropyl methacrylamide hydrochloric acid salt; diethylaminoethylacrylate; diethylaminoethylmethacrylate; diallyldiethylammonium chloride; and diallyldimethyl ammonium chloride.

In another embodiment, the present invention provides a method of encapsulating bituminous or heavy oil materials in subterranean wells comprising adding to a drilling fluid, used in drilling into said wells, an additive wherein said additive is a copolymer as described above.

In another embodiment the present invention provides an additive for drilling fluids wherein said additive is a copolymer as described above.

### BRIEF DESCRIPTION OF THE DRAWINGS

These and other features of the embodiments of the invention will become more apparent in the following detailed description in which reference is made to the appended drawings wherein:

FIG. 1 shows the condition of a rolling bar after being rolled in a drilling fluid that fails to prevent bitumen accretion.

FIG. 2 shows the condition of a cell and a rolling bar after rolling continuously for 65 hours with 15% w/v bituminous material in a drilling fluid comprising the cationic polymer Ultimer™ 7753 in a concentration of 1% v/v.

FIG. 3 shows the condition of a cell and a rolling bar after rolling continuously for 65 hours with 25% w/v bituminous material in a drilling fluid comprising the cationic polymer Ultimer™ 7753 in a concentration of 1% v/v.

FIG. 4 shows a comparison between a standard polymer system and the viscosified Ultimer™ 7753 system with 20% w/v bituminous material.

### DESCRIPTION OF THE INVENTION

In one embodiment, the present invention provides an aqueous drilling fluid containing, as an additive, a water soluble cationic polymer for preventing the accretion of bitumen, or heavy oil, to metal or other surfaces of drill components during subterranean drilling operations. The cationic polymer acts as an encapsulation agent, which is capable of encapsulating bitumen by charge attraction. Bitumen is known to have an overall anionic charge, with mixed hydrophobic and hydrophilic surface regions. The cationic polymer encapsulates bituminous materials (e.g. sand, shale, clay) by a cationic/anionic interaction. In the result, bitumen is hindered from contacting the surface of drilling components and accretion is inhibited. Further, the use of the drilling fluid of the present invention allows for the use of conventional solids control equipment, such as gravity settling sand traps or mechanical means such as centrifuges, shale shakers or hydrocyclones, for removing contaminants from the drilling fluid. These methods are not effective for drilling fluids utilizing a solvent system of the prior art. In a solvent system oil floats on the surface of the drilling fluid and must be sucked off the top of the fluid when it comes to the surface using vacuum trucks.

In one embodiment, the drilling fluid of the present invention comprises a cationic polymer which is a copolymer comprising acrylamide, or a substituted acrylamide such as methacrylamide, and cationic monomers.

Representative cationic monomers include acrylates and their quaternary or acid salts, including, but not limited to, dimethylaminoethyl acrylate methyl chloride quaternary salt, dimethylaminoethyl acrylate methyl sulfate quaternary salt, dimethyaminoethyl acrylate benzyl chloride quaternary salt, dimethylaminoethyl acrylate sulfuric acid salt, dimethylaminoethyl acrylate hydrochloric acid salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dialkylaminoalkylacrylamides or methacrylamides and their quaternary or acid salts such as acrylamidopropyltrimethylammonium chloride, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate, diallyldiethylammonium chloride and diallyldimethyl ammonium chloride. Alkyl groups are generally C₁₋₄ alkyl. U.S. Pat. No. 6,605,674 (herein incorporated by reference) provides a further description of processes for producing cationic polymers which can be used in the drilling fluid of the present invention.

In one embodiment, the aforementioned water soluble cationic polymer has the formula:
([R₁]ₓ-[R₂]_{y})_{z} (I)
wherein,
R₁ is an acrylamide, or substituted acrylamide;
R₂ is a cationic monomer;
x and y range from 1 to 20;
z ranges from 1 to 1,000,000.

The acrylamide portion of the cationic polymer used in the drilling fluid of the present invention may be substituted. For example, the acrylamide portion may be methacrylamide. However, an individual skilled in the art will recognize other possible substituent groups for the acrylamide portion of the cationic polymer which will not alter the capacity of the cationic polymer to encapsulate bitumen or heavy oil.

In one embodiment of the present invention R₂ is an acrylate or, quaternary or acid salt of acrylates.

Chains of R₂ monomers may be linear or branched. Chains of R₂ monomers may comprise the same acrylate salt (e.g. all dimethylaminoethylacrylate methyl chloride monomers) or mixtures of acrylate salts (e.g. dimethylaminoethylacrylate methyl chloride and dimethylaminoethylacrylate benzyl chloride etc.).

In one embodiment of the invention, the aqueous drilling fluid comprises an acrylamide/dimethylaminoethylacrylate benzyl chloride cationic polymer, or an acrylamide/dimethylaminoethylacrylate methyl chloride cationic polymer, or an acrylamide/acryloxyetheyltrimethylammonium chloride cationic polymer.

In another embodiment of the present invention, the water soluble cationic polymer has the Formula (II):
([R₁]ₓ-[R′]ₐ-[R₂]_{y}-[R″]_{b})_{z} (II)
wherein,
R₁ is acrylamide or substituted acrylamide;
R₂ is a cationic monomer quaternary acrylate salt;
R′ and R″ are non-anionic organic groups;
x, y range from 1 to 20;
a and b range from 0 to 20;
z ranges from 1 to 1,000,000.

The acrylamide portion of the cationic polymer used in the drilling fluid of the present invention may be substituted. For example, the acrylamide portion may be methacrylamide. However, an individual skilled in the art will recognize other possible substituent groups for the acrylamide portion of the cationic polymer which will not alter the capacity of the cationic polymer to encapsulate bitumen or heavy oil.

In one embodiment of the present invention R₂ is an acrylate or, quaternary or acid salt of acrylates.

Chains of R₂ monomers may be linear or branched. Chains of R₂ monomers may comprise the same acrylate salt (e.g. all dimethylaminoethylacrylate methyl chloride monomers) or mixtures of acrylate salts (e.g. dimethylaminoethylacrylate methyl chloride and dimethylaminoethylacrylate benzyl chloride etc.).

The R′ and R″ groups may be branched, linear, cyclic or substituted. Chains of R′ and R″ groups may be the same or combinations of different non-anionic (i.e. cationic or neutral) organic groups. Examples of R′ and R″ groups include, but are not limited to, branched, linear, or cyclic alkyl chains, and branched, linear, or cyclic alkyl chains substituted with amine groups.

The molecular weight of the cationic polymer utilized in the drilling fluid of the present invention has a molecular weight ranging from 250 grams to 50 million grams per mole. Preferably, the molecular weight of the cationic polymer ranges between 3 million and 15 million grams per mole.

A drilling fluid according to the invention has a concentration of the cationic encapsulating polymer sufficient for inhibiting the accretion of bitumen to exposed metal and non-metal surfaces present on the drilling apparatus. In one embodiment, the concentration of the cationic polymer is greater than 0% and less than about 10% of the drilling fluid by volume. The upper concentration limit has been established for two reasons. Firstly, using a concentration of the cationic polymer beyond the upper limit of 10% by volume becomes cost prohibitive. Secondly, it becomes increasingly difficult to pump a drilling fluid with a concentration of cationic polymer exceeding the disclosed concentration limit due to an increase in the viscosity of the drilling fluid. Preferably the concentration range of the cationic polymer is between 0.01% and 2% by volume.

The cationic polymer of the drilling fluid of the present invention possesses a cationic charge and can be quantitatively measured. Further, in one embodiment the cationic polymer has a cationic charge ranging between 1 to 100 mole percent.

In a further embodiment of the present invention, the cationic polymer used in the drilling fluid of the present invention is a dispersion polymer. A “dispersion polymer”, as defined herein, is a dispersion of fine particles of polymer in an aqueous salt solution which is prepared by polymerizing monomers with stirring in an aqueous salt solution in which the resulting polymer is insoluble (See U.S. Pat. Nos. 5,708,071; 4,929,655; 5,006,590; 5,597,859; 5,597,858 and European Patent nos. 657,478 and 630,909, all incorporated herein by reference).

Dispersion polymers can eliminate the use of hydrocarbon solvents and surfactants which are used in emulsion polymerization. These solvents and surfactants are the primary cause of Volatile Organic Compounds (VOC's) in these products. Since dispersion polymers consist of stable colloids in a salt solution they do not produce VOC's while still maintaining their ease and safety of handling. Due to the stable nature of the colloids, dispersion polymers do not suffer from settling problems thereby avoiding the need for expensive mixing equipment.

In an additional embodiment, a drilling fluid may also comprise one or more of the following known drilling fluid additives; a viscosifier or water, a fluid loss additive, a weighting agent or agents, and a bridging agent or agents. The additional drilling components being selected from compounds that do not interact with or become encapsulated by the cationic encapsulating polymer. Such components are commonly known in the art and further discussion of same is provided below.

Viscosifiers are substances used for thickening organic or aqueous drilling fluids. Examples of viscosifiers which could be used for the disclosed aqueous drilling fluid include the non-ionic viscosifiers, attapulgite, bentonite and scleroglucan. The present invention is not limited to these specific viscosifiers. Non-ionic viscosifiers are used in the drilling fluid in order to prevent interactions between the viscosifier and the cationic polymer, which limit the effectiveness of the drilling fluid for encapsulation of bitumen. In the examples presented below, a scleroglucan viscosifier was utilized. Rheology testing, as described below, can be used to verify that no interaction between the viscosifier and the cationic polymer occurred. The test described in the examples below could be utilized for viscosifiers other than scleroglucan and cationic polymers other than an acrylamide/dimethylaminoethylacrylate benzyl chloride polymer.

In an additional embodiment of the disclosed drilling fluid it is also possible to use the cationic polymer with only water without the use of a viscosifier. However, in an embodiment comprising only water and the cationic polymer, the flow rate of drilling fluid must be maintained at a high level in order to clean drill cuttings out of the hole.

Weighting materials can be included in the drilling fluid in order to increase the density of the drilling fluid. Generally, weight materials are inert, high density particulate solid materials. The size of a particulate is usually smaller than 75 microns. Examples of weighting agents include: barite, hematite, iron oxide, calcium carbonate, magnesium carbonate or combinations of these compounds. As will be apparent to persons skilled in the art, the present invention is not limited to these weighting materials.

Fluid loss additives can be included in the drilling fluid in order to prevent the drilling fluid from invading into porous subterranean formations under the action of temperature and pressure. Examples of fluid loss additives include: modified starches, lignites, polyanionic celluloses (PAC's) and modified carboxymethyl celluloses (CMC's) and mixtures of these compounds. The present invention is not limited to these fluid loss additives.

Bridging agents can be included in the drilling fluid in order to seal off the pores of subterranean formations that are contacted by drilling fluid. These agents are characterized by a particle size distribution which can sufficiently seal the subterranean pores. Examples of bridging materials that could be used in the present invention include: calcium carbonate, polymers, fibrous material, or hydrocarbon based materials, and mixtures of these. The present invention is not limited to these bridging agents.

An additional embodiment of the present invention provides a method of encapsulating bituminous or heavy oil materials in subterranean wells comprising adding to a drilling fluid, used in drilling into said wells, an additive comprising the cationic polymer as described above.

Another embodiment of the present invention provides an additive for drilling fluids. Specifically, the additive comprising the cationic polymer as described above.

In an alternate embodiment, the drilling fluid of the present invention further comprises a salt. When the drilling fluid of the present invention is pressurized, the addition of a salt may synergistically enhance the ability of the cationic polymer to encapsulate bitumen or heavy oil. For example, in drilling fluids comprising a viscosifier the addition of a salt, when used at a specific concentration, will prevent the attraction of the cationic polymer to the viscosifier if the viscosifier has an anionic charge (e.g. Xanthan gum). The ability of the salt to prevent this attraction is the result of the natural mobility of the salt cations, which are attracted to anionic sites of the viscosifier. Since the salt cations are smaller and more mobile than the cationic polymer they can move faster and closer to the viscosifier anionic sites, thereby repelling the cationic charge of the polymer, as like charges repel each other. Since the size of salt cations is at least an order of magnitude smaller than the polymer they cannot encapsulate the viscosifier. As such, the viscosifier is not pulled out of solution as it would be if it interacted with the cationic polymer. This salt/viscosifier interaction allows the viscosifier to fully hydrate and provide viscosity.

If salt is included in the drilling fluids of the present invention, the concentration of the salt in the drilling fluid should be greater than zero but less than 20% by volume. The reason for these limits are cost and environmental concerns for the discharge of the fluids.

Examples of salts that may be used in the present drilling fluid include, but are not limited to, potassium sulfate, ammonium sulfate, calcium chloride, potassium acetate, and potassium chloride.

Although the invention has been described with reference to certain specific embodiments, various modifications thereof will be apparent to those skilled in the art without departing from the spirit and scope of the invention as outlined in the claims appended hereto.

The examples presented below are provided to illustrate the present invention and are not meant to limit the scope of the invention as will be apparent to persons skilled in the art.

### EXAMPLE #1

### Rhelogical Testing of Drilling Fluid

Method: In order to establish a rheology profile of the drilling fluid, two concentrations of scleroglucan viscosifier (5 and 7 kg/m³) were mixed with 1% v/v of a cationic polymer (the cationic polymer used for this test was an acrylamide/dimethylaminoethylacrylate benzyl chloride polymer). Rheology of the viscosifier was assessed before and after the addition of the cationic polymer for the purpose of determining whether the cationic polymer displayed any detrimental effects on the fluid properties of the viscosifier. In addition, the drilling fluid was rolled at room temperature for hours, and the rheology was re-measured after this time period had elapsed. Results are presented in Table 1 and Table 2.

TABLE 1
shows the results of the fluid rheologies before rolling.

| | | 5 Kg/m³ | | 7 Kg/m³ |
|---|---|---|---|---|
| | | scleroglucan + | | scleroglucan + |
| | 5 Kg/m³ | cationic | 7 Kg/m³ | cationic |
| | scleroglucan | polymer | scleroglucan | polymer |
| 600/300 | 19/15 | 32/24 | 26/20 | 37/29 |
| 200/100 | 13/11 | 20/16 | 18/15 | 25/21 |
| 6/3 | 7/6 | 10/9 | 10/9 | 12/11 |
| Gels (Pa) | 3/4.5 | 4/4.5 | 4.5/6 | 5/6 |
| PV/YP | 4/5.5 | 8/8 | 6/7 | 6/11.5 |
| (cps/Pa) | | | | |

TABLE 2
shows the rheology results of the fluids with cationic polymer after rolling
for 16 hours

| | 5 Kg/m³ | 7 Kg/m³ |
|---|---|---|
| | scleroglucan + cationic | scleroglucan + cationic |
| | polymer | polymer |
| 600/300 | 29/21 | 38/29 |
| 200/100 | 17/13 | 24/19 |
| 6/3 | 7/6 | 10/9 |
| Gels (Pa) | 3/4 | 4.5/6 |
| PV/YP (cps/Pa) | 8/6.5 | 9/10 |

Wherein plastic viscosity (PV) is a parameter of the Bingham plastic rheological model. PV is the slope of the shear stress/shear rate line above the yield point. PV represents the viscosity of a mud when extrapolated to infinite shear rate on the basis of the mathematics of the Bingham model. A low PV indicates that the mud is capable of drilling rapidly because of the low viscosity of mud exiting at the bit. High PV is caused by a viscous base fluid and by excess colloidal solids. The 600/300, 200/100 and 6/3 values correspond to the speed that the dial readings are taken on a Fann™ 35 viscometer. These values have units of reciprocal seconds. The plastic viscosity (PV) is calculated from the 600 reading minus the 300 reading. The yield point (YP) is calculated from the 300 reading minus the PV.

A parameter of the Bingham plastic Theological model. YP is the yield stress extrapolated to a shear rate of zero. A Bingham plastic fluid plots as a straight line on a shear-rate x-axis) versus shear-stress (y-axis) plot, in which YP is the zero-shear-rate intercept. YP is calculated from 300 minus PV where 300 is the speed at which the dial reading is taken. YP is used to evaluate the ability of a mud to lift cuttings out of the annulus. A high YP implies a non-Newtonian fluid, one that carries cuttings better than a fluid of similar density but lower YP.

The gel strength (Gels) is shear stress measured at a low shear rate after a mud has set quiescently for a period of time (10 seconds and 10 minutes in the standard API procedure, although measurements after 30 minutes or 16 hours may also be made).

Based on the results observed it was determined that, in the drilling fluid of the present invention, the cationic polymer had no detrimental effect on rheology. In order to further verify these findings, the 7 kg/m³ sample was rolled for an extended time period of 110 hours. After this time period had elapsed, the same rheology profile as had been reported for the 16 hour sample was obtained.

### EXAMPLE #2

### Method to Test the Effectiveness of a Drilling Fluid for Preventing Accretion of Bitumen

A qualitative testing method, as described below, was used to assess the ability of a drilling fluid to limit or prevent accretion of bituminous material. Specifically, the method involved rolling a cylindrical steel bar, having a diameter of 3 cm and length of 7 cm, in a drilling fluid to be tested, with 10% to 20% wt/vol bitumen (tar) sand. The steel rods were added to the drilling fluid prior to the addition of bitumen, which ensured that the surface of the rods were completely coated with drilling fluid. If bitumen had been added to the fluid at the same time as the rods, the surface of the rods would not have been completely coated by the drilling fluid, and would have been subject to bitumen accretion. The test was performed in a rolling cell, and the cell was rolled at room temperature for approximately 16 hours. If a drilling fluid prevented accretion of bitumen to the surface of the steel rods during this time period, the drilling fluid was given a pass grade. Before testing, the steel rods and rolling cell were sanded to ensure that each had clean surfaces. A number of polymers were tested using this methodology in order to identify what type of polymers could be used for encapsulation of bitumen. The results of this testing are presented in Table 3.

Once it was determined that a drilling fluid could prevent accretion during the 16 hour time period, the drilling fluid was then subjected to extended duration rolling tests, as well as rolling tests in which higher concentrations of bitumen (tar) sand were used.

Based on these results, it was determined that cationic polymers of the above-mentioned molecular formula (I) were capable of bitumen encapsulation. More specifically, two cationic polymers were identified as having bitumen encapsulation capabilities. The two cationic polymers were an acrylamide/dimethylaminoethylacrylate benzyl chloride polymer (Ultimer™ 7753) and an acrylamide/dimethylaminoethylacrylate methyl chloride polymer (Nalco™ 9909). Further, testing showed that 1% v/v of the acrylamide/dimethylaminoethylacrylate benzyl chloride cationic polymer, was capable of encapsulating >25% w/v of tar sand.

TABLE 3
Accretion Rolling Test Results

| Additive | Additive Concⁿ | Tar Sand Concⁿ | System Chemistry | Pass/Fail |
|---|---|---|---|---|
| Zetag 7869 | 0.5% (^{w}/ᵥ) | 10% (^{w}/ᵥ) | Encapsulation | Fail |
| Zetag 7873 | 1% (^{v}/ᵥ) | 20% (^{w}/ᵥ) | Encapsulation | Fail |
| Zetag 7878 | 1% (^{v}/ᵥ) | 20% (^{w}/ᵥ) | Encapsulation | Fail |
| Zetag 7875 FS25 | 1% (^{v}/ᵥ) | 20% (^{w}/ᵥ) | Encapsulation | Fail |
| Zetag 7821 | 0.5% (^{w}/ᵥ) | 10% (^{w}/ᵥ) | Encapsulation | Fail |
| Zetag 7692 | 0.5% (^{w}/ᵥ) | 20% (^{w}/ᵥ) | Encapsulation | Pass |
| Genkat | 1% (^{v}/ᵥ) | 10% (^{w}/ᵥ) | Encapsulation | Fail |
| Nalco 7139 Plus | 1% (^{v}/ᵥ) | 10% (^{w}/ᵥ) | Encapsulation | Fail |
| Nalco 9909* | 0.5% (^{w}/ᵥ) | 10% (^{w}/ᵥ) | Encapsulation | Pass |
| Ultimer 7753 | 1% (^{v}/ᵥ) | 10% (^{w}/ᵥ) | Encapsulation | Pass |
| Ultimer 7753¹ | 1% (^{v}/ᵥ) | 10% (^{w}/ᵥ) | Encapsulation | Pass |
| Ultimer 7753² | 1% (^{v}/ᵥ) | 15% (^{w}/ᵥ) | Encapsulation | Pass |
| Ultimer 7753 | 1% (^{v}/ᵥ) | 15% (^{w}/ᵥ) | Encapsulation | Pass |
| No Additive (Water)³ | — | 20% (^{w}/ᵥ) | — | Fail |
| Ultimer 7753³ | 1% (^{v}/ᵥ) | 20% (^{w}/ᵥ) | Encapsulation | Pass |
| Ultimer 7753 | 1% (^{v}/ᵥ) | 25% (^{v}/ᵥ) | Encapsulation | Pass |
| A-Cyclodextrin | 1% (^{w}/ᵥ) | 10% (^{w}/ᵥ) | Encapsulation | Fail |
| B-Cyclodextrin | 1% (^{w}/ᵥ) | 10% (^{w}/ᵥ) | Encapsulation | Fail |
| Y-Cylcodextrin | 1% (^{w}/ᵥ) | 10% (^{w}/ᵥ) | Encapsulation | Fail |
| Glycerine | 1% (^{v}/ᵥ) | 10% (^{w}/ᵥ) | Encapsulation | Fail |
| SMA 1440H | 1% (^{v}/ᵥ) | 10% (^{w}/ᵥ) | Encapsulation | Fail |
| SMA 1000NA | 1% (^{v}/ᵥ) | 10% (^{w}/ᵥ) | Encapsulation | Fail |
| SMA 2625H | 1% (^{v}/ᵥ) | 10% (^{w}/ᵥ) | Encapsulation | Fail |
| Drillam EF | 0.85% (^{v}/ᵥ) | 10% (^{w}/ᵥ) | Encapsulation | Fail |

^{1&2}Fluids rolled for 65hours at room temperature.
³These fluids were viscosified.

### EXAMPLE #3

### Pressurized Testing of Drilling Fluid and Salt

TABLE 4
Results of Pressurized Rolling Testing and Salt

| | | Tar Sand | |
|---|---|---|---|
| Additive | Additive Concⁿ | Concⁿ | Pass/Fail |
| Potassium Sulfate | 3 kg/m³ | 20% (^{w}/ᵥ) | Fail |
| Ammonium Sulfate | 3 kg/m³ | 20% (^{w}/ᵥ) | Fail |
| Calcium Chloride | 3 kg/m³ | 20% (^{w}/ᵥ) | Fail |
| Potassium Acetate | 3 kg/m³ | 20% (^{w}/ᵥ) | Fail |
| Potassium Carbonate | 3 kg/m³ | 20% (^{w}/ᵥ) | Fail |
| Potassium Chloride | 3 kg/m³ | 20% (^{w}/ᵥ) | Fail |
| Genkat + Potassium | 2.5 l/m³ + 3 kg/m³ | 20% (^{w}/ᵥ) | Pass |
| Sulfate | | | |
| Genkat + Ammonium | 2.5 l/m³ + 3 kg/m³ | 20% (^{w}/ᵥ) | Pass |
| Sulfate | | | |
| Genkat + Potassium | 2.5 l/m³ + 3 kg/m³ | 20% (^{w}/ᵥ) | Fail |
| Chloride | | | |
| Genkat + Potassium | 2.5 l/m³ + 3 kg/m³ | 20% (^{w}/ᵥ) | Pass |
| Acetate | | | |
| Genkat + Potassium | 2.5 l/m³ + 3 kg/m³ | 20% (^{w}/ᵥ) | Fail |
| Carbonate | | | |
| Genkat + Calcium | 2.5 l/m³ + 3 kg/m³ | 20% (^{w}/ᵥ) | Fail |
| Chloride | | | |
| Zetag 7692 | 5 kg/m³ | 20% (^{w}/ᵥ) | Fail |
| Zeta 7692 + Potassium | 5 kg/m³ + 3 kg/m³ | 20% (^{w}/ᵥ) | Pass |
| Sulfate | | | |
| Ultimer 7753 | 5 l/m³ | 20% (^{w}/ᵥ) | Pass |
| Ultimer 7753 + Zetag 7692 | 5 l/m³ + 5 kg/m³ | 20% (^{w}/ᵥ) | Pass |

Method: An additional test was conducted to determine the effect of adding salt to the drilling fluid of the present invention, and the effect of extended pressurization of the drilling fluid for encapsulation of bitumen or heavy oil.

Testing involved preparing 350 ml of a test solution and then placing a steel bar with dimensions of 7.5 cm by 3 cm in the test solution in a rolling cell. 70 grams (20% w/v) of bitumen sand was then broken up and added to the rolling cell. The cell was then pressurized up to 500 psi and rolled for 40 minutes at room temperature. After the 40 minute period had elapsed the cell was de-pressurized and the rolling bar and cell inspected. A pass was given if the cell and steel bar were free of bitumen accretion.

The results presented in Table 4 illustrate that the various salts tested were not capable of bitumen encapsulation when used individually in a drilling fluid. However the anion of certain salts may play a role in synergistically helping the cationic encapsulation polymer coat the bitumen solids when the drilling fluid is pressurized, for example for extended periods of time. Sulfate and acetate salts were particularly effective in preventing bitumen accretion when used with cationic polymers, while chloride and carbonate salts were not effective. It is possible, however, that chloride or carbonate salts used in conjunction with cationic polymers not tested in this experiment may work synergistically with other cationic polymers to prevent bitumen accretion.

Although the above example provides examples of types of salts that can be included in the drilling fluid of the present invention, the salts are not limited to the type of salts that have been tested. An individual skilled in the art will recognize other anions which might be able to be used, such as phosphates, nitrates etc.

To prove that other cationic polymers could be used in conjunction with a salt, a cationic polymer was chosen that had failed to prevent the accretion of bitumen in previous testing. The cationic polymer used was Genkat™. When tested with the original testing procedure the cell and rolling bar were coated with bitumen. However, when re-tested under pressure with a sulfate or acetate salt in conjunction with Genkat, the testing showed that the bitumen had been encapsulated and no accretion/sticking was observed.

It is possible that the anion from the salt neutralizes any cationic charge existing on the bitumen surface, thereby allowing the cationic encapsulation polymer to completely interact with the bitumen's negatively charged surface without being repelled by any existing cationic charges.

### EXAMPLE #4

### Salt/Viscosifier Interactions

Table 4 presents the results of tests conducted in order to determine the effect of adding salt to the drilling fluid of the present invention. As discussed above, the inclusion of salt in a drilling fluid also containing a viscosifier and a cationic polymer prevents the interaction of the cationic polymer with the anionic viscosifier. In the example provided in table 4 the viscosifier used was xanthum gum. The results show that a drilling fluid comprising a cationic polymer and an anionic viscosifier, in the presence of salt, maintains its viscosity, while a drilling fluid comprising only the cationic polymer and the viscosifier loses its viscosity.

TABLE 4
Rheologies of Drilling Fluids Containing Salt, Viscosifier and
Cationic Polymer

| | | | 5 Kg/m³ XCD + 1% | 5 Kg/m³ XCD + 1% | 5 Kg/m³ XCD + 1% |
|---|---|---|---|---|---|
| | | | Ultimer 7753 | Ultimer 7753 | Ultimer 7753 |
| | | 5 Kg/m³ XCD + 1% | cationic polymer + 10 kg/m³ | cationic polymer + 15 kg/m³ | cationic polymer + 18 kg/m³ |
| | 5 Kg/m³ | Ultimer 7753 | Ammonium | Ammonium | Ammonium |
| | XCD | cationic polymer | sulfate | sulfate | sulfate |
| 600/300 | 30/24 | 19/12 | 23/15 | 36/28 | 37/29 |
| 200/100 | 21/18 | 10/7 | 15/12 | 24/20 | 25.5/21 |
| 6/3 | 11/10 | 2/1.5 | 4/3 | 10/8.5 | 10.5/9.5 |
| Gels | 5/6 | 1/1 | 2/2 | 5/5 | 5/6 |
| (Pa) | | | | | |
| PV/YP | 6/9 | 7/2.5 | 8/3.5 | 8/10 | 8/10.5 |
| (cps/Pa) | | | | | |

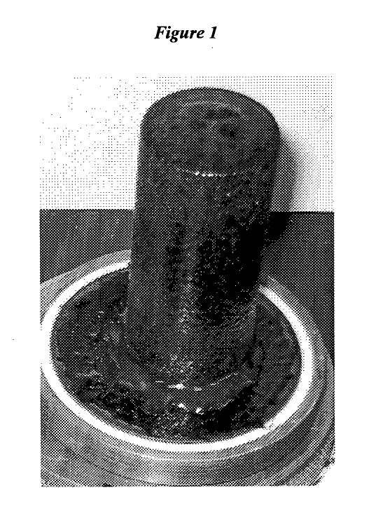

FIGS. 1 to 4 are photographs presenting some of the results obtained during the above-mentioned rolling tests for accretion prevention. FIG. 1 depicts a rolling bar, after being rolled for 16 hours with 10% w/v tar sand, in a drilling fluid containing a polymer which failed to prevent bitumen accretion. The bar is covered by a thick layer of bitumen and the drilling fluid is congested with bitumen

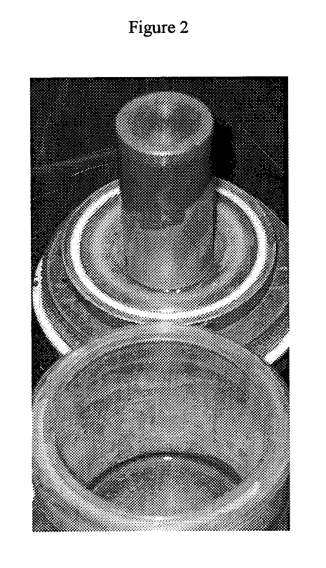

FIG. 2 shows the condition of a cell and a rolling bar after rolling continuously for 65 hours with 15% w/v bituminous material in a drilling fluid comprising the cationic polymer Ultimer™ 7753 in a concentration of 1% v/v. This embodiment of the drilling fluid has prevented bitumen accretion.

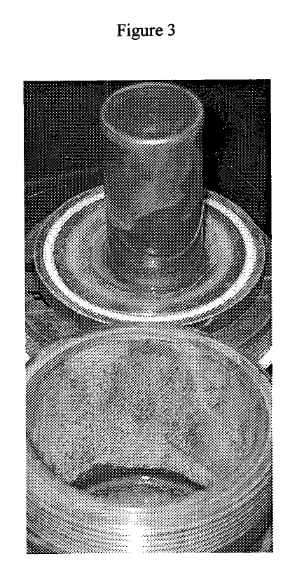

FIG. 3 shows the condition of a cell and a rolling bar are after rolling continuously for 65 hours with 25% w/v bituminous material in a drilling fluid comprising the cationic polymer Ultimer™ 7753 in a concentration of 1% v/v. This embodiment of the drilling fluid has once again prevented bitumen accretion, even though the concentration of bituminous material was increased.

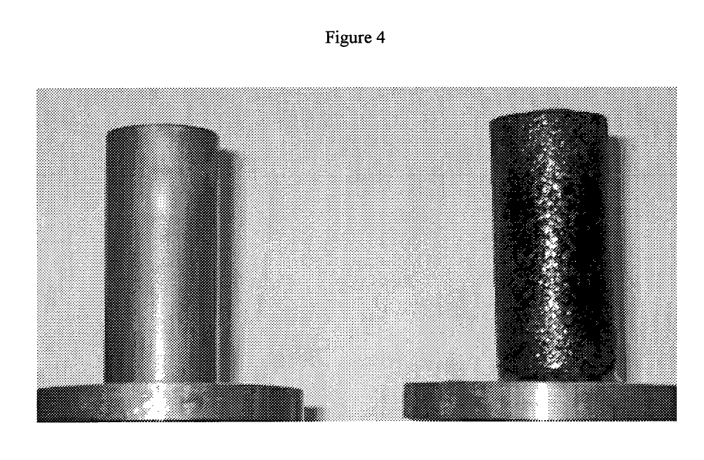

FIG. 4 presents a comparison between a standard polymer drilling fluid and an embodiment of the drilling fluid containing the cationic polymer Ultimer™ 7753. The depicted bars were rolled in a 20% w/v concentration of bituminous material. The drilling fluid also contained a scleroglucan viscofier. The bar rolled in the standard polymer drilling fluid (right) failed to prevent accretion of bitumen and is coated in bitumen. The viscosified drilling fluid has prevented accretion of bitumen to the surface of the rolling bar (left). The presence of the scleroglucan viscosifier in the drilling fluid has not inhibited the ability of the cationic polymer Ultimer™ 7753 from preventing bitumen accretion.

The embodiments of the invention in which an exclusive property or privilege is claimed are defined as follows:

1. An aqueous drilling fluid for drilling wells through a formation containing bitumen and/or heavy oil sands, the drilling fluid comprising:
a water soluble cationic polymer, wherein said cationic polymer is a copolymer comprising acrylamide or substituted acrylamide, and cationic monomers.

2. The aqueous drilling fluid of claim 1 wherein the cationic monomers are acrylates or, quaternary or acid salts of acrylates.

3. The aqueous drilling fluid of claim 2 wherein cationic monomers are selected from the group consisting of dimethylaminoethyl acrylate methyl chloride quaternary salt; dimethylaminoethyl acrylate methyl sulfate quaternary salt; dimethyaminoethyl acrylate benzyl chloride quaternary salt; dimethylaminoethyl acrylate sulfuric acid salt; dimethylaminoethyl acrylate hydrochloric acid salt; dimethylaminoethyl methacrylate methyl chloride quaternary salt; dimethylaminoethyl methacrylate methyl sulfate quaternary salt; dimethylaminoethyl methacrylate benzyl chloride quaternary salt; dimethylaminoethyl methacrylate sulfuric acid salt; dimethylaminoethyl methacrylate hydrochloric acid salt; dialkylaminoalkylacrylamides or methacrylamides and their quaternary or acid salts such as acrylamidopropyltrimethylammonium chloride; dimethylaminopropyl acrylamide methyl sulfate quaternary salt; dimethylaminopropyl acrylamide sulfuric acid salt; dimethylaminopropyl acrylamide hydrochloric acid salt; methacrylamidopropyltrimethylammonium chloride; dimethylaminopropyl methacrylamide methyl sulfate quaternary salt; dimethylaminopropyl methacrylamide sulfuric acid salt; dimethylaminopropyl methacrylamide hydrochloric acid salt; diethylaminoethylacrylate; diethylaminoethylmethacrylate; diallyldiethylammonium chloride; and diallyldimethyl ammonium chloride.

4. The aqueous drilling fluid of claim 1 wherein the cationic polymer has the general formula
([R₁]ₓ-[R′]ₐ-[R₂]_{y}-[R″]_{b})_{z} (II)
wherein,
R₁ is acrylamide or substituted acrylamide;
R₂ is a cationic monomer;
R′ and R″ are non-anionic organic groups;
x, y range from 1 to 20;
a and b range from 0 to 20;
z ranges from 1 to 1,000,000.

5. The drilling fluid of claim 4 wherein the cationic monomer is an acrylate or, quaternary or acid salt of an acrylate.

6. The drilling fluid of claim 1 wherein the water soluble cationic polymer is a dispersion polymer.

7. The drilling fluid of claim 1 wherein the water soluble cationic polymer has a cationic charge ranging between 1 and 100 mole percent.

8. The drilling fluid of claim 1 wherein the water soluble cationic polymer has a molecular weight ranging between 250 and 50 million grams per mole.

9. The drilling fluid of claim 8 wherein the water soluble cationic polymer has a molecular weight ranging between 3 million and 15 million grams per mole.

10. The drilling fluid of claim 1 further comprising one or more of the following additives; a viscosifier, fluid loss additives, weighting agents, a salt and bridging materials.

11. The drilling fluid of claim 10 wherein the viscosifier is selected from the group consisting of non-ionic, cationic polymers, attapulgite, bentonite or scleroglucan.

12. A method of encapsulating bituminous or heavy oil materials in subterranean wells comprising adding to a drilling fluid, used in drilling into said wells, an additive wherein said additive is a copolymer comprising acrylamide or substituted acrylamide, and cationic monomers.

13. The method of claim 12 wherein the cationic monomers are acrylates or quaternary or acid salts of acrylates.

14. The method of claim 13 wherein cationic monomers are selected from the group consisting of dimethylaminoethyl acrylate methyl chloride quaternary salt; dimethylaminoethyl acrylate methyl sulfate quaternary salt; dimethyaminoethyl acrylate benzyl chloride quaternary salt; dimethylaminoethyl acrylate sulfuric acid salt; dimethylaminoethyl acrylate hydrochloric acid salt; dimethylaminoethyl methacrylate methyl chloride quaternary salt; dimethylaminoethyl methacrylate methyl sulfate quaternary salt; dimethylaminoethyl methacrylate benzyl chloride quaternary salt; dimethylaminoethyl methacrylate sulfuric acid salt; dimethylaminoethyl methacrylate hydrochloric acid salt; dialkylaminoalkylacrylamides or methacrylamides and their quaternary or acid salts such as acrylamidopropyltrimethylammonium chloride; dimethylaminopropyl acrylamide methyl sulfate quaternary salt; dimethylaminopropyl acrylamide sulfuric acid salt; dimethylaminopropyl acrylamide hydrochloric acid salt; methacrylamidopropyltrimethylammonium chloride; dimethylaminopropyl methacrylamide methyl sulfate quaternary salt; dimethylaminopropyl methacrylamide sulfuric acid salt; dimethylaminopropyl methacrylamide hydrochloric acid salt; diethylaminoethylacrylate; diethylaminoethylmethacrylate; diallyldiethylammonium chloride; and diallyldimethyl ammonium chloride.

15. The method of claim 12 wherein the cationic polymer has the general formula
([R₁]ₓ-[R′]ₐ-[R₂]_{y}-[R″]_{b})_{z} (II)
wherein,
R₁ is acrylamide or substituted acrylamide;
R₂ is a cationic monomer;
R′ and R″ are non-anionic organic groups;
x, y range from 1 to 20;
a and b range from 0 to 20;
z ranges from 1 to 1,000,000.

16. The method of claim 15 wherein the cationic monomer is an acrylate or, quaternary or acid salt of an acrylate.

17. The method of claim 12 wherein the water soluble cationic polymer is a dispersion polymer.

18. The method of claim 12 wherein the water soluble cationic polymer has a cationic charge ranging between 1 and 100 mole percent.

19. The method of claim 12 wherein the water soluble cationic polymer has a molecular weight ranging between 250 and 50 million grams per mole.

20. The method of claim 19 wherein the water soluble cationic polymer has a molecular weight ranging between 3 million and 15 million grams per mole.
